(19) United States
(12) Patent Application Publication
(10) Pub. No.: US 2018/0308158 A1
(43) Pub. Date: Oct. 25, 2018

(54) AN OPTIMAL CREDIT RATING DIVISION METHOD BASED ON MAXIMIZING CREDIT SIMILARITY

(71) Applicant: Dalian University of Technology, Dalian City, Liaoning Province (CN)

(72) Inventors: Guotai CHI, Dalian City, Liaoning Province (CN); Zhichong ZHAO, Dalian City, Liaoning Province (CN)

(21) Appl. No.: 15/765,584

(22) PCT Filed: Apr. 19, 2016
(86) PCT No.: PCT/CN2016/079681

§ 371 Date: Apr. 3, 2018

(51) Int. Cl. G06Q 40/02; G06F 17/18; G06F 17/15; G06K 9/62

(52) U.S. Cl. CPC G06Q 40/025; G06K 9/6234; G06F 17/15; G06F 17/18

(57) ABSTRACT

The invention supplies to an optimal credit rating division method based on maximizing credit similarity, which belongs to the field of credit services technology. The invention provides a credit rating method, which meets the essential attribute of credit that the higher credit rating comes with the lower corresponding LGD, and ensures that customers with big credit status difference are divided into the different level and customers with similar credit status are divided into the same level. This invention constructs a nonlinear programming model to divide the credit rating based on maximizing credit similarity, whose objective function aims at minimizes the deviation of credit scores within the group, and maximum the deviation of credit scores between groups, with the constraint that the LGD is strictly increasing with credit rating from high to low.

### FIELD

The invention relates to an optimal credit rating division method based on maximizing credit similarity, which belongs to the field of credit services technology.

### BACKGROUND

Credit rating has an important impact on the contemporary society. Whether sovereign credit rating, bank credit rating, corporate credit rating, or individual credit rating, it will mislead creditors and the public if the credit rating is unreasonable. The changes of credit rating results directly reflect the changes of the economic status, which causes the close attention of investors and the public. The changes of sovereign credit rating results reflect the changes of the country's economic situation; the changes of corporate bond rating results marks the changes of operating conditions for the business or financial enterprises.

The essence of credit rating is to classify the customers according to their credit level which means customers with different credit risk level should be divided into different credit rating. Credit rating system includes the selection of indicators, the weight of indicators, the determination of customer credit score and the division of credit rating, and the division of credit rating is the most important result in credit risk management; it will mislead the creditors and social public to make the wrong investment decisions if the credit rating division is unreasonable. Therefore, the division of credit rating is particularly important.

The first type of credit ratings is divided according to the idea of credit scores range or based on the idea that default probability is more than a certain threshold. The credit rating management consulting system (SIPO No. 200810139934.8) including financial analysis, credit rating, risk management system and other 15 modules, has the advantages of clear structure, easy to be expanded and easy to reuse. Credit rating system (SIPO No. 201010546434.3) provides an information system to carry out the credit rating service for the credit rating agencies. “Currency and credit rating system for business-to-business transaction” (U.S. Pat. No. 6,965,878) divides credit rating by the credit score range. “Credit risk mining” (WIPO No. WO/2012/012623) develops credit risk models to calculate the probability of the enterprise credit rating, default rate and so on, using various sources of data, including financial accounting ratios, and environmental data.

The deficiencies of the first type of existing credit ratings related patents are existed: the existing credit ratings do not meet the nature of the credit attributes that the higher credit rating comes with the lower corresponding loss given default (LGD). Therefore, many credit rating systems, whose indicators seemed perfect, often get strange results that customers with higher credit rating have higher corresponding LGD.

The second type of credit ratings is divided customers into different credit levels by default pyramid principle that customers with lower LGD should be divided into higher level. “A Credit Rating System and Method Based on Matching Credit Rating and Loss Given Default” (SIPO No. 201210201461.6) and “A Reverse Adjustment Algorithm for Credit Rating Based on Credit Rating and Loss Given Default Matching” (SIPO No. 201210201114.3) divided credit rating according to the default pyramid principle that customers with lower LGD should be divided in higher level, which meet the nature of credit rating.

The second type of existing credit ratings related patents divided credit rating according to the default pyramid principle that customers with lower LGD should be divided in higher level meets the nature of credit rating. Due to different research angles, these two patents did not consider the criteria that the greater credit similarity, the more it should be divided into the same credit rating, which will lead to the mistake that customers with similar credit status are divided into the different level.

This invention constructs a nonlinear programming model to divide the credit rating based on maximizing credit similarity, whose objective function aims at minimizes the deviation of credit scores within the group, and maximum the deviation of credit scores between groups, with the constraint that the LGD is strictly increasing with credit rating from high to low. Under the premise that customers with similar credit status are more likely to be divided into the same credit level, this invention ensures that customers with different credit status are divided into different levels, and credit rating classification can meet the pyramid standard that customers with lower LGD should be divided in higher level.

### SUMMARY

The purpose of this invention is to provide a credit rating method, which meets the essential attribute of credit that the higher credit rating comes with the lower corresponding LGD, and ensures that customers with big credit status difference are divided into the different level and customers with similar credit status are divided into the same level.

Technical solutions of this invention are as follows:

The invention constructs a Multi-objective programming model to divide the credit rating with the objective function that minimizes the deviation of credit scores within the group, and maximum the deviation of credit scores between groups, with the constraint that the LGD is strictly increasing with credit rating from high to low.

The credit rating method includes the following steps:

Credit rating system includes the establishment the credit risk evaluation index system, the weight of credit risk evaluation indicators, the determination of customer credit risk evaluation equation and the division of credit rating; The credit score of the i^{th} customer Sᵢ are determined by credit risk evaluation index system, the weight of indicators and the equation of customer credit risk evaluation, provides a data base for the credit rating. And finally the customers will be divided into 9 credit rating based on the credit score; where n denotes the total number of customers, i=1, 2, . . . n.

Step 1: Determination the Credit Score Sᵢ

(1) Establishment the credit risk evaluation index system: Firstly, the invention uses the Fisher discriminant method to select the indicators that can significantly distinguish default and non-default customers from many extensive indicators; then the invention uses correlation analysis method to delete the indicators of repeated information from the indicators above significantly distinguish default and non-default customers, and gets the credit risk evaluation index system.

(2) Determine the weight of credit risk evaluation indicators: the invention uses the method of mean square deviation to weight the credit risk evaluation indicators from the step 1 (1), the bigger the mean square deviation of indicator, the greater the weight.

(3) Determine of customer credit risk evaluation equation:

Using linear weighing method, the credit risk evaluation equation Sᵢ=Σωⱼxᵢⱼ is established with credit risk evaluation index system and weight of indicator. The credit score Sᵢ can be obtained; where ωⱼ denotes the weight of j^{th} indicator, xᵢⱼ denotes the value of the j^{th} indictor and the i^{th} customer, n denotes the total number of customers, m denotes the indicator number of credit risk evaluation index system, i=1, 2, . . . n, j=1, 2, . . . m.

The establishment of the credit risk evaluation index system and weight of indicators are the basis to calculate the credit score Sᵢ, and there are many methods can calculate the credit score.

Step 2: Data Import

Import the credit score Sᵢ obtained in step 1 for all customers to be divided, the owed loan capital and interest Lᵢₖ and the receivable loan capital and interest Rᵢₖ into Excel, all customers are ranking in accordance with the credit score from high to low.

Step 3: Credit Rating Dividing

Customer's credit rating result is obtained by using the optimal algorithm for credit rating dividing based on maximizing credit similarity, and then the result will be displayed on the Excel automatically.

The optimal algorithm for credit rating dividing based on maximizing credit similarity includes:

(1) The objective function 1: The deviation of credit scores within the group should be minimized. That is to say min f₁=g₁(Sₖ, Sₖᵢ), where Sₖ denotes the mean value of all customers' credit scores in the k^{th} credit rating, Sₖᵢ denotes the credit score of the i^{th} customer in the k^{th} credit rating, k=1, 2, 3, 4, 5, 6, 7, 8, 9, i=1, 2, . . . .

(2) The objective function 2: The deviation of credit scores between groups should be maximized. That is to say max f₂=g₂(Sₖ, S), where Sₖ denotes the mean value of all customers' credit scores in the k^{th} credit rating, S denotes the mean value of all customers' credit scores in 9 credit rating, k=1, 2, 3, 4, 5, 6, 7, 8, 9.

(3) The constraint condition 1: The LGD increase strictly with credit rating from high to low, namely:

0<LGD₁<LGD₂<LGD₃<LGD₄<LGD₅<LGD₆<LGD₇<LGD₈<LGD₉≤1.

(4) The constraint condition 2: the equality constraint is calculating LGDₖ of the k^{th} credit rating. That is to say LGDₖ=h(Lᵢₖ, Rᵢₖ), where Lᵢₖ denotes the owed loan capital and interest of the k^{th} credit rating and the i^{th} customer, and Rᵢₖ denotes the receivable loan capital and interest of the k^{th} credit rating and the i^{th} customer, k=1, 2, 3, 4, 5, 6, 7, 8, 9, i=1, 2, . . . .

The optimal credit rating results are obtained by solving the Multi-objective programming model, which consists of the objective functions 1, 2 and the constraint conditions 1, 2 in step 3. The optimal credit rating dividing meets the pyramid standard, and ensures that customers with similar credit status are more likely to be divided into the same credit level and customers with different credit status are divided into different levels.

The benefits of this invention are as follow:

Firstly, this invention provides an optimal credit rating division method based on maximizing credit similarity, which meets the essential attribute of credit that the higher credit rating comes with the lower corresponding LGD, and ensures that customers with similar credit status are more likely to be divided into the same credit level and customers with different credit status are divided into different levels. Taking farmers loan data of a national large scale commercial bank in China and small business loan data of a Chinese commercial bank for example, the results of these two empirical samples not only meet the pyramid principle, but also own the advantage that ensures the customers with similar credit status are divided into the same level, and customers with different credit status are divided into different levels.

Secondly, the credit rating result that meets the higher credit rating with the lower corresponding LGD can be obtained without infinite adjusting. Because the change of a credit rating customers' number or LGD will cause the change of the sequence of every credit rating's LGD in the credit rating system. As is well known rational number between any two points on the number axis is infinite, it is impossible to find out a reasonable credit rating result that the higher credit rating comes with the lower corresponding LGD by using the trial-and-error method.

Thirdly, the credit grade classification has the advantage of the stability interval, which avoids the length of credit score interval too large or too small. If the credit score interval is too small, and the customer credit score slightly changes, the customer's credit rating will be changed, and the LGD will correspondingly change. If the credit score interval is too large, even if the credit score changed greatly, the customer's credit rating will not change. So it will mislead the creditors and social public to make wrong investment decisions if credit score interval don't have the advantage of stability.

Fourthly, based on the default status in different credit ratings, the default risk has been fully compensated in the loan pricing for bonds and other financial instruments.

Fifthly, the credit rating result obtained by using this method not only provides the sort of credit rating of the customer solvency like the existing research and practice, but also provides the default rate and LGD of each credit rating. It reveals more useful information than the existing bank credit rating system.

Sixthly, according to the default rates of different levels revealed by the rating results, the credit rating system enables the commercial banks, bond investors, other creditors and the public to understand the default status of each credit rating and make investment decisions.

### BRIEF DESCRIPTION OF THE DRAWINGS

FIG. 1 is the default pyramid distribution figure of credit rating and loss given default (LGD).

FIG. 2 is the distribution figure of credit rating not matching the LGD.

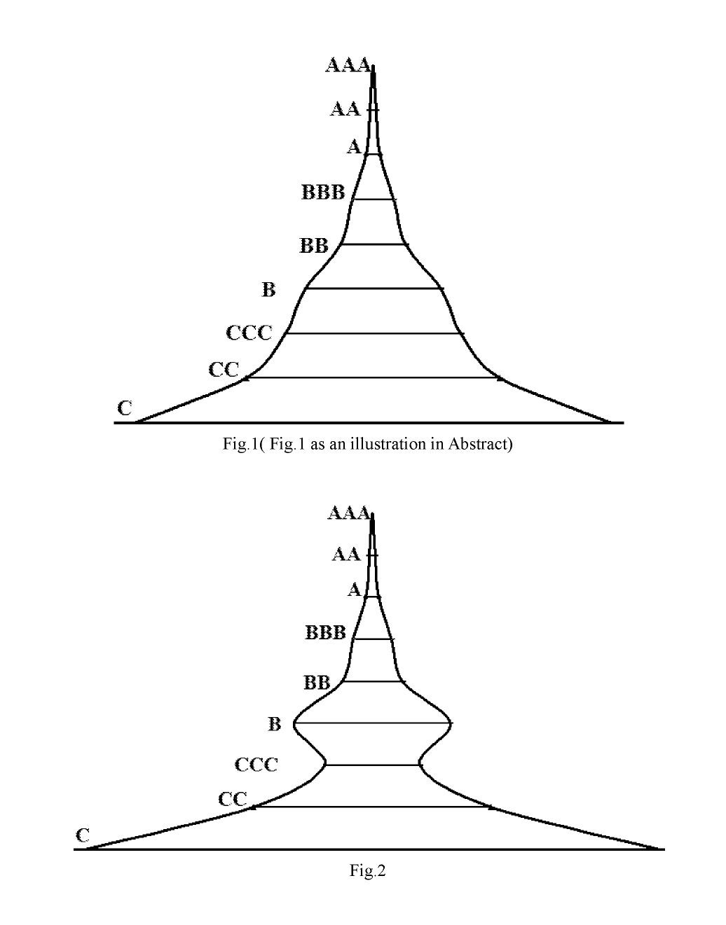

In figure, AAA, AA, A, BBB, BB, B, CCC, CC and C represent the 9 credit rating from high to low, the length of horizontal line in pyramid represents the LGDₖ of the credit rating, the 9 LGD of credit rating in FIG. 1 satisfied LGD_{AAA}=0.130%, LGD_{AA}=0.263%, LGD_{A}=0.684%, LGD_{BBB}=6.040%, LGD_{BB}=9.543%, LGD_{B}=24.452%, LGD_{CCC}=33.868%, LGD_{CC}=35.448%, LGD_{C}=90.044%; the LGD of CCC rating is less than B rating in FIG. 2.

### DETAILED DESCRIPTION

The further explains the concrete implementation method of the invention combined with the attached map and the technical solution.

The invention reveals a process of the credit rating division method based on maximizing credit similarity.

The invention provides an optimal credit rating division method based on maximizing credit similarity, the credit rating division satisfies the essential attribute of credit that the higher credit rating, the lower corresponding LGD, and also satisfies that the customers with similar credit status are more likely to be divided into the same credit level and the customers with large difference of credit status are divided into different levels.

The implementation procedures of the invention are shown as follows:

Take 1814 small industrial enterprises loan data of a regional Chinese commercial bank as an example to show the invention, the specific steps of the empirical analysis are shown as follows:

Credit rating system includes the establishment the credit risk evaluation index system, the weight of credit risk evaluation indicators, the determination of customer credit risk evaluation equation and the division of credit rating; The credit score of the i^{th} customer Sᵢ are determined by credit risk evaluation index system, the weight of indicators and the equation of customer credit risk evaluation, provides a data base for the credit rating. And finally the customers will be divided into 9 credit rating based on the credit score; where n denotes the total number of customers, i=1, 2, . . . n.

Step 1: Determination the Credit Score Sᵢ

(1) Establishment the credit risk evaluation index system: Firstly, the invention uses the Fisher discriminant method to select the indicators that can significantly distinguish default and non-default customers from many extensive indicators; then the invention uses correlation analysis method to delete the indicators of repeated information from the indicators above significantly distinguish default and non-default customers, and gets the credit risk evaluation index system.

(2) Determine the weight of credit risk evaluation indicators: the invention uses the method of mean square deviation to weight the credit risk evaluation indicators from the step 1 (1), the bigger the mean square deviation of indicator, the greater the weight.

(3) Determine of customer credit risk evaluation equation:

Using linear weighing method, the credit risk evaluation equation Sᵢ=Σωⱼxᵢⱼ is established with credit risk evaluation index system and weight of indicator. The credit score Sᵢ can be obtained; where ωⱼ denotes the weight of j^{th} indicator, xᵢⱼ denotes the value of the j^{th} indictor and the i^{th} customer, n denotes the total number of customers, m denotes the indicator number of credit risk evaluation index system, i=1, 2, . . . n, j=1, 2, . . . m.

The credit risk evaluation index system is shown in column 2^{nd} of table 1, and the index weights are shown in column 3^{rd} of table 1.

TABLE 1
The credit risk evaluation index system and index weights

| (1) No. | (2) Indicator xᵢ | (3) Weight ωᵢ |
|---|---|---|
| 1 | X₁ Cash coverage ratio of liquid | 0.035 |
| | liabilities and Operating activities | |
| 2 | X₂ Main business income cash ratio | 0.027 |
| 3 | X₃ Equity ratio | 0.031 |
| . . . | . . . | . . . |
| 24 | X₂₄ Legal disputes | 0.175 |
| 25 | X₂₅ Mortgage guarantee score | 0.038 |

The establishment of the credit risk evaluation index system and weight of indicators are the basis to calculate the credit score Sᵢ, and there are many methods can calculate the credit score.

Step 2: Data Import

Import the credit score Sᵢ obtained in step 1 for all customers to be divided, the owed loan capital and interest Lᵢₖ and the receivable loan capital and interest Rᵢₖ into Excel, all customers are ranking in accordance with the credit score from high to low.

Step 3: Credit Rating Dividing

Customer's credit rating result is obtained by using the optimal algorithm for credit rating dividing based on maximizing credit similarity, and then the result will be displayed on the Excel automatically. The credit rating results include: the customer number of different credit rating mₖ, the loss given default of different credit rating LGDₖ (k=1, 2, 3, 4, 5, 6, 7, 8, 9), the credit risk evaluation score interval of different credit rating, the value of objective function, and the default pyramid distribution, they are shown in FIG. 1.

The optimal algorithm for credit rating dividing based on maximizing credit similarity includes:

(1) The objective function 1: The deviation of credit scores within the group should be minimized. That is to say min f₁=g₁(Sₖ, Sₖᵢ), where Sₖ denotes the mean value of all customers' credit scores in the k^{th} credit rating, Sₖᵢ denotes the credit score of the i^{th} customer in the k^{th} credit rating, k=1, 2, 3, 4, 5, 6, 7, 8, 9, i=1, 2, . . . .

The objective function 1 can ensure that the customers with the more similar credit risk evaluation score can be divided into the same credit rating, it can avoid the customers with large credit score difference are divided into the same level, which will cause the length of credit score interval too large, and lead to the credit rating classification intervals have no differentiation.

(2) The objective function 2: The deviation of credit scores between groups should be maximized. That is to say max f₂=g₂(Sₖ, S), where Sₖ denotes the mean value of all customers' credit scores in the k^{th} credit rating, S denotes the mean value of all customers' credit scores in 9 credit rating, k=1, 2, 3, 4, 5, 6, 7, 8, 9.

The objective function 2 can ensure that the credit score differences as large as possible for different credit rating, it avoids the drawbacks that the length of credit score interval is too small, and the credit score results changing are too sensitive and lack of stability as the customer credit score slightly changed.

(3) The constraint condition 1: The LGD increase strictly with credit rating from high to low, namely:

0<LGD₁<LGD₂<LGD₃<LGD₄<LGD₅<LGD₆<LGD₇<LGD₈<LGD₉≤1.

The constraint condition 1 ensures that credit rating results meet the essential attribute of credit that the higher credit rating comes with the lower corresponding LGD by setting the constraint that the LGD increasing strictly as the credit rating changes from high to low. It has changed the existing rating system, which leads to a strange phenomenon that the higher credit rating comes with the higher corresponding LGD.

(4) The constraint condition 2: the equality constraint is calculating LGDₖ of the k^{th} credit rating. That is to say LGDₖ=h(Lᵢₖ, Rᵢₖ), where Lᵢₖ denotes the owed loan capital and interest of the k^{th} credit rating and the i^{th} customer, and Rᵢₖ denotes the receivable loan capital and interest of the k^{th} credit rating and the i^{th} customer, k=1, 2, 3, 4, 5, 6, 7, 8, 9, i=1, 2, . . . .

The constraint condition 2 ensures that the measurement of loss given default reflect the bank's real loss, by comparing the customers' owed loan capital and interest Lₖᵢ and the customers' receivable loan capital and interest Rₖᵢ, it has solved the problem of calculating LGD for each credit rating.

It should be pointed out: if the objective functions are not related with the credit score in the present invention, and just use the existing credit rating patent methods (SIPO No. 201210201461.6 and 2012102001114.3), it will lead to the result of credit rating having not the advantage of the stability credit score interval, which means the length of credit score interval being too large or too small. If the credit score interval is too small, the customer's credit rating will be changed as long as the customer credit score slightly changes. The credit score interval is too sensitive. If the credit score interval is too large, the customer's credit rating will not change even if the credit score changes greatly. The credit score intervals have no differentiation.

Taking the 1814 small industrial enterprises loans data of a regional Chinese commercial bank for example, use the method mentioned in the present invention to make an empirical analysis and to divide the credit rating. The results of credit rating based on maximizing credit similarity are shown in table 2.

TABLE 2
the credit score interval and LGD for each credit rating

| | | | (4) Length of | |
|---|---|---|---|---|
| (1) | (2) Credit | (3) Credit score | credit score | (5) Loss given |
| No. | rating | interval | interval | default LGDₖ |
| 1 | AAA | 73.41 ≤ S ≤ 100 | 26.59 | 0.130% |
| 2 | AA | 66.03 ≤ S < 73.41 | 7.38 | 0.263% |
| 3 | A | 60.11 ≤ S < 66.03 | 5.92 | 0.684% |
| 4 | BBB | 34.02 ≤ S < 60.11 | 26.09 | 6.040% |
| 5 | BB | 29.20 ≤ S < 34.02 | 4.82 | 9.543% |
| 6 | B | 27.28 ≤ S < 29.20 | 1.92 | 24.452% |
| 7 | CCC | 26.23 ≤ S < 27.28 | 1.05 | 33.868% |
| 8 | CC | 17.66 ≤ S < 26.23 | 8.57 | 35.448% |
| 9 | C | 0 ≤ S < 17.66 | 17.66 | 90.044% |

In table 2, column 3^{rd} shows the credit score interval and column 4^{th} shows the length of credit score interval which is determined from column 3^{rd}. The minimum value of the credit score interval length is 1.05, which is 26 times as much as the mean difference 0.04 of the two adjacent credit score within the 1814 loan customers. The credit score interval has a certain distinction degree.

Taking the LGDₖ in Column 5^{th} of Table 2 as the horizontal axis, and the corresponding credit rating k as the vertical axis, the pyramid distribution diagram of LGD is shown as FIG. 1. From the Column 5^{th} of Table 2, the corresponding LGDₖ of 9 credit ratings strictly increase, the credit rating result meets the essential attribute of credit that the higher credit rating, the lower corresponding LGD. In Column 4^{th} of Table 2, the length of credit score interval has a stability distribution, which reflects customers with similar credit status are more likely to be divided into the same credit level and the customers with the more different credit status are more easily divided into different levels.

There are various implementation manners of this invention, so all technological solutions formed by equivalent replacement or equivalent transformation of the present invention “An Optimal Credit Rating Division Method Based on Maximizing Credit Similarity” will all fall within the scope of this invention required protection.

1. An optimal credit rating division method based on maximizing credit similarity includes the following steps:
Step 1: determining a credit score Sᵢ;
Step 2: receiving the credit score Sᵢ obtained in step 1 for a plurality of customers, receiving an owed loan capital amount for each customer and interest Lᵢₖ rate, and receiving a receivable loan capital amount and interest Rᵢₖ rate, then ranking the customers based on the credit score of each customer from high to low; and
Step 3: obtaining a credit rating result for each customer by using an optimal algorithm for credit rating dividing based on maximizing credit similarity, and then displaying the credit rating result automatically,
wherein the optimal algorithm for credit rating dividing based on maximizing credit similarity includes:
(1) objective function 1: minimizing deviation of the credit scores within a group, following:
min f₁=g₁(Sₖ, Sₖᵢ), where Sₖ denotes a mean value of the credit scores in the k^{th} credit rating, Sₖᵢ denotes the credit score of the i^{th} customer in the k^{th} credit rating, k=1, 2, 3, 4, 5, 6, 7, 8, 9, i=1, 2, . . . ;
(2) objective function 2: maximizing deviation of the credit scores between groups, following:
max f₂=g₂(Sₖ, S), where Sₖ denotes the mean value of credit scores in the k^{th} credit rating, S denotes a mean value of the credit scores in nine credit rating groups, k=1, 2, 3, 4, 5, 6, 7, 8, 9;
(3) constraint condition 1: increase a loss-given-default (LGD) strictly with credit rating from high to low, namely: 0<LGD₁<LGD₂<LGD₃<LGD₄<LGD₅<LGD₆<LGD₇<LGD₈<LGD₉≤1;
(4) constraint condition 2: calculating a equality constraint calculating LGDₖ of the k^{th} credit rating, following:
LGDₖ=h(Lᵢₖ, Rᵢₖ), where Lᵢₖ denotes the owed loan capital amount and interest rate of the k^{th} credit rating and the i^{th} customer, and Rᵢₖ denotes the receivable loan capital amount and interest rate of the k^{th} credit rating and the i^{th} customer, k=1, 2, 3, 4, 5, 6, 7, 8, 9, i=1, 2, . . . ;
wherein the optimal credit rating result for each customer is obtained by solving a multi-objective programming model, the multi-objective programming model applying the objective function 1, the objective function 2, the constraint condition 1, and the constraint condition 2 in step 3;
wherein the credit rating dividing by the optimal algorithm meets the pyramid standard, and ensures that the customers with similar credit status are divided into a same credit level and the customers with different credit status are divided into different levels.

2. The optimal credit rating division method of claim 1, wherein determining the credit score Sᵢ in step 1 includes the following steps:
(1.1) establishing a credit risk evaluation index system, by: applying a Fisher discriminant method to select indicators that can significantly distinguish default and non-default customers from many extensive indicators; then applying a correlation analysis method to delete indicators of repeated information from the indicators that significantly distinguish default and non-default customers, and obtaining the credit risk evaluation index;
(1.2) determining a weight for each of the credit risk evaluation indicators, by: applying a mean square deviation method to weight the credit risk evaluation indicators from the step 1.1, wherein larger mean square deviation for a particular indicator, results in a greater weight for the particular indicator;
(1.3) calculating a customer credit risk evaluation equation, the credit risk evaluation equation being Sᵢ=Σωⱼxᵢⱼ is established with the credit risk evaluation index system of step 1.1 and weight of indicator of step 1.2, wherein the credit score Sᵢ is obtained; where ωⱼ denotes the weight of j^{th} indicator, xᵢⱼ denotes a value of the j^{th} indictor and the i^{th} customer, n denotes the total number of customers, m denotes the indicator number of credit risk evaluation index system, i=1, 2, . . . n, j=1, 2, . . . m.
